(19) United States
(12) Patent Application Publication
(10) Pub. No.: US 2002/0073129 A1
(43) Pub. Date: Jun. 13, 2002

(54) Integrated multi-component scheduler for operating systems

(76) Inventors: Yu-Chung Wang, Irvine, CA (US); Kwei-Jay Lin, Irvine, CA (US)

Correspondence Address: Kwei-Jay Lin, 15 Whistler Ct., Irvine, CA, 92612, US

(21) Appl. No.: 09/728,385

(22) Filed: Dec. 4, 2000

(51) Int. Cl. G06F 9/00

(52) U.S. Cl. 709/102

(57) ABSTRACT

An integrated multi-component scheduling process is invented that may emulate various scheduling methods. For general purpose operating systems, the integrated scheduling method can be used to provide more powerful capabilities as many commonly used scheduling methods, including priority-driven, time-driven, and share-driven methods. With a multi-component structure, scheduling policy components can be separated from scheduling mechanism components in an operating system scheduler. The integrated scheduling method can also be used to combine several scheduling policies into one method.

### TECHNICAL FIELD OF THE INVENTION

The present invention is generally related to task scheduling mechanisms in computer operating systems, and, in particular, to control the scheduling of applications with critical and sensitive real-time and performance requirements.

### BACKGROUND OF THE INVENTION

Many applications such as video-conferencing, distributed interaction environments, avionics systems, traffic control system and automated factory systems require real-time computation and communication services.

In real-time systems, all real-time tasks are defined by their timing specifications, such as periodic or sporadic, deadline, rate, and the like. It is the responsibility of the system builder to choose an operating system that may schedule and execute these tasks, as well as meet their system resource (memory, file, video, and the like) requests, according to their timing specifications as precisely as possible.

To date, three main scheduling paradigms have been used to schedule real-time tasks, namely, priority-driven, share-driven, and time-driven. The most common scheduling approach to implement real-time systems is to adopt a periodic process model and use the priority-driven scheduling paradigm. Priority-driven (PD) scheduling is implemented by assigning priorities to tasks. Tasks ready for execution are placed in one or more queues ordered or dictated by the priorities of tasks. At any scheduling decision time, the task with the highest priority is selected and executed. The share-driven (SD) scheduling paradigm is based on the GPS (General Processor Sharing) algorithm. In the context of network packet scheduling, GPS serves packets as if they are in separate logical queues, visiting each nonempty queue in turn and serving an infinitesimally small amount of data from each queue. Using the SD approach for OS (operating system) scheduling, every real-time task is requested with a certain CPU share (or weight). The scheduler tries to allocate computing resources according to the requested share from each task. All tasks share computing resources according to the ratios based on their requested shares.

For systems with steady and well-known input data streams, time-driven (TD) (or clock-driven) schedulers have been used to provide a very predictable processing power for each data stream. In this scheduling paradigm, the schedule of all real-time tasks is defined by the time instances when each task starts, preempts, resumes and finishes. The schedule is then enforced by the scheduler.

To be used by embedded and real-time applications, two important properties for an operating system kernel are the efficiency and the flexibility. Many Unix (RTM by AT&T) operating system variants, such as Linux (RTM by Linux Torvalds) and Solaris, provides POSIX-compliant priority-driven scheduling. However, many hard real-time applications need time-driven scheduling since time-driven scheduling is a proven technology used in many classical real-time applications. There are also some new scheduling algorithms, such as share-driven, or proportional sharing algorithm and its approximations, for real-time applications and communication network with end-to-end delay constraint.

It is desirable for an operating system to support many scheduling algorithms since different applications may need to use different algorithms, or even application-dependent variations. Current operating systems are usually designed to support only one scheduling policy. Since operating system schedulers are implemented in the very core of the system code, or in the kernel, they are very difficult to modify. So operating systems usually do not allow users to change the behavior of their scheduler. Some operating systems have implemented several default policies and allow users to select one to schedule user tasks at a given time. However, only a fixed set of the pre-implemented scheduling algorithms can be selected. Users cannot make application dependent schedulers.

Accordingly, it is possible to design an operating system using an integrated multi-component scheduler to support real-time applications. Additional objects, advantages and novel features of the invention is set forth in part in the description which follows, and in part becomes apparent to the those who are skilled in the art upon practicing of the invention.

### SUMMARY OF THE INVENTION

In this invention, we disclose an integrated multi-component scheduling mechanism to allow many scheduling algorithms to be supported in one operating system in a flexible manner. Instead of building each of the many scheduling algorithms as a separate and independent scheduler and collecting them in an operating system, the invention discloses a mechanism that integrates these algorithms in a general framework. The mechanism identifies the basic scheduling attributes for each sub-task and directly supports (or enforces) them in the operating system. By adjusting attribute values and selection criteria based on these attributes, it is possible to emulate many existing scheduling algorithms easily. Moreover, by supporting algorithms from different paradigms in one common framework, we can integrate these basic scheduling algorithms and produce many new scheduling algorithms for different applications.

The innovation of our invention is that we have designed a scheduling process to efficiently support different real-time schedulers in one operating system. Since most embedded real-time applications need a predictable yet efficient scheduler, many embedded system designers need to build their own schedulers. Our invention allows operating systems to be easily reconfigured with application-dependent schedulers without modifying the complex low-level kernel scheduling mechanism.

The integrated multi-component scheduling process from our invention defines multiple scheduler components in an operating system for making scheduling decisions. In particular, a scheduling “policy” from a scheduling “mechanism” is separable according to the disclosures of the invention. In this disclosure, a scheduling mechanism defines “how” to do the scheduling whereas a scheduling policy decides “what” will be done. For example, a mechanism for lining up all user processes to be executed is to use a process queue. The decision of which process should be selected from the queue first for execution is a policy decision. It has been generally agreed that the separation of policy from mechanism makes a system more flexible, and more powerful in most cases. Moreover, the kernel scheduling mechanism is very complex and should not be modified by inexperienced programmers. By separating policy components from mechanism components, programmers can design their own policy components without the risk of making an operating system extremely fragile or prone to failure.

Using the teaching of the present invention, an OS scheduler is implemented by multiple components: some for implementing policies and others for implementing mechanisms. In this way, different scheduling policies can be implemented and deployed at run time by the same operating system. This is useful for implementing real-time systems with many different applications, each of which needs a different scheduler. Different policies can be easily deployed at different times since they share the same scheduling mechanism.

In one preferred embodiment, a process for scheduling tasks in an operating system using a plurality set of scheduler components may comprise sub-processes of: given a user program, a first set of said plurality set of scheduler components dividing or transforming the user program into at least one sub-task; said at least one sub-task having a set of performance attributes, wherein values of said set of performance attributes are assigned by said first set of scheduler components; the first set of scheduler components placing the at least one sub-task on a waiting queue of a receiving scheduler component, wherein said receiving schedule component belongs to a second set of said plurality set of scheduler components; and said second set of scheduler components selecting a next sub-task to be executed by a CPU of the operating system from all sub-tasks on the waiting queue based on a selection function using the performance attributes of said all sub-tasks.

In another preferred embodiment, an operating system scheduler using a plurality set of scheduler components comprises: a first set of said plurality set of scheduler components having a plurality of sub-tasks, wherein said first set of scheduler components is programmed to implement different scheduling policies and uses different algorithms for different user programs; a second set of said plurality set of scheduler components, wherein said second set of scheduler components uses a simple mechanism to select a next sub-task to be executed by a CPU; same set of scheduler components being used as the second set of scheduler components for different user programs; and the first set of scheduler components assigning different scheduling attributes to control the second set of scheduler components in selecting the next sub-task to be executed by said CPU.

In a still preferred embodiment, an operating system using a plurality set of scheduler components and an operating system kernel comprises: a first set of said plurality set of scheduler components having a plurality of sub-tasks, wherein said first set of scheduler components is a part of a user program for the operating system; and a second set of said plurality set of scheduler components, wherein said second set of scheduler components is a part of the operating system kernel.

### BRIEF DESCRIPTION OF THE DRAWINGS

Additional objects and features of the present invention will become more apparent and the invention itself will be best understood from the following Detailed Description of Exemplary Embodiments, when read with reference to the accompanying drawings.

FIG. 1 presents an overview of the operating scheduler components as defined in accordance with the present invention.

FIG. 2 shows an alternate scheduler structure where some scheduler components are user space.

FIG. 3 shows a preferred embodiment for the scheduler with only two components.

FIG. 4 shows the scheduler with multiple sub-tasks generated from a single user program.

FIG. 5 shows the flowchart of the scheduler components #2 in FIG. 1.

FIGS. 6-9 are flowcharts illustrating the processing flow of sub-processes in FIG. 5.

FIG. 10 presents a table showing the assignment of scheduling attributes for four different scheduling algorithms.

### DETAILED DESCRIPTION OF EXEMPLARY EMBODIMENTS

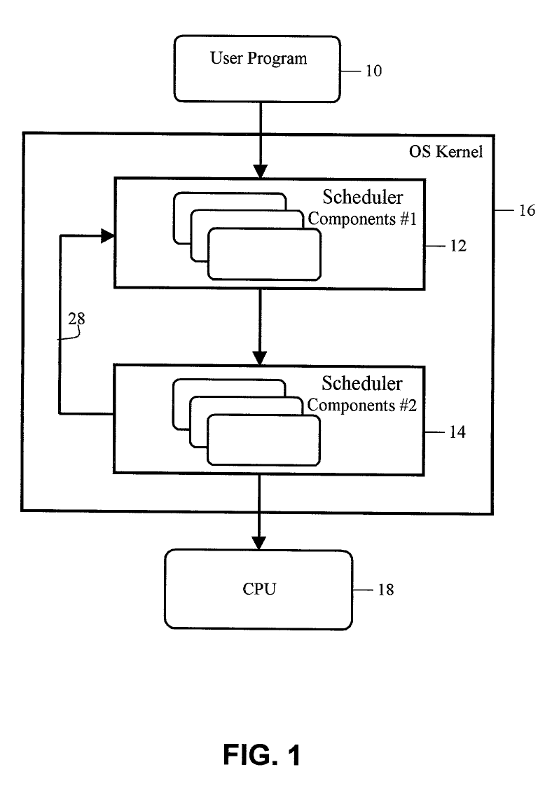

Referring to FIGS. 1 to 10, what is shown is an embodiment of an integrated multi-component scheduler for operating systems in accordance with the present invention.

An operating system (OS) is responsible for managing system resources for user applications so that all applications can finish their executions as efficiently as possible. Most of today's operating systems are designed to be “multi-tasking”, i.e. they can manage more than one task at any time. One of the functions in an OS is to schedule tasks that co-exist in a system for execution using some scheduling algorithms. Different algorithms may produce different task execution schedules. Some of those schedules are considered to be more desirable than others. For example, a desirable schedule is that all tasks are finished as early as possible.

A real-time system scheduler is responsible for assigning system resources to each real-time application according to its performance requirement. Real-time applications have different performance requirements from non-real-time applications. For example, a common real-time requirement is that a task must be finished by a “deadline”. Again different real-time scheduling algorithms can produce different performances for the same set of user tasks. A real-time application should use a scheduling algorithm that best meets its needs. However, most operating systems provide only a very limited selection of scheduling algorithms. It is difficult, if not impossible, for applications to adopt a customized scheduling algorithm.

### Scheduler Components

The object of the present invention is to provide a scheduling process that can provide customized kernel scheduler for each application. FIG. 1 shows an overview of the operating scheduler components as defined in accordance with the present invention. A user program 10 sends its task execution request to the OS kernel 16. The scheduling request is sent to a first set of scheduler components 12. The performance requirement of the task as defined by the user program 10 is given to the first set of scheduler components which maps it into low level attributes assigned to each sub-task. The sub-task is then placed on some waiting queue in a second set of scheduler components 14. The second set of scheduler components then decides which sub-task should be executed by CPU 18 by a selection function or criterion based on the attributes as its parameters. The second set of scheduler components 14 may send some feedback information 28 to the first set of scheduling components 12. The feedback information may include actual execution behaviors, status of some sub-tasks, and the like.

The scheduler structure in FIG. 1 includes two sets of components. Although both sets are still included in the OS kernel, this structure allows the first set to implement the scheduling policies and the second set to implement the scheduling mechanism. The separation of scheduling policy and scheduling mechanism of the present invention makes the scheduler structure much more flexible and efficient.

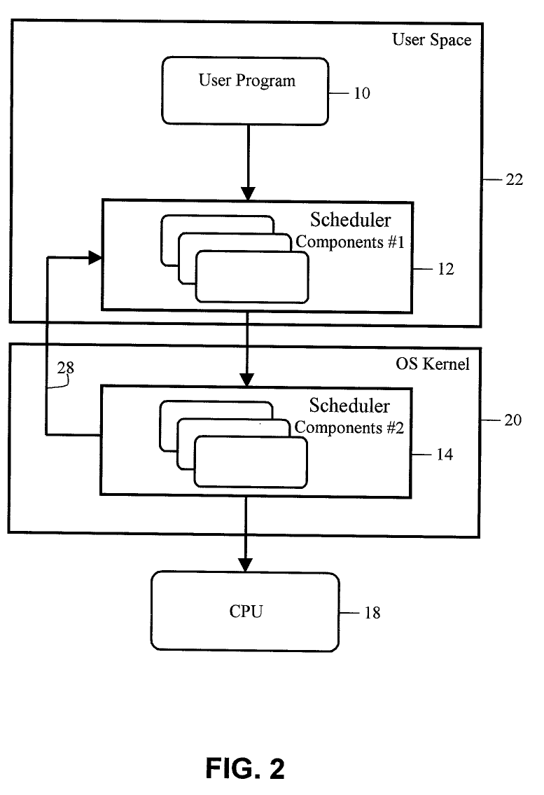

FIG. 2 shows the same scheduler structure as in FIG. 1 except that the first set of scheduler components is not in the OS kernel 20. The first set of scheduler components 12 is now in the user space 22 just like the user program 10 in the user space 22. This shows the flexibility and capability of the present invention since user programs now may include scheduler components customized to their needs. The customized scheduler components can be changed without modifying the second set of scheduler components 14. The first set of scheduler components may be selected from at least one pre-defined scheduling method in the user space. The process for scheduling tasks in an operating system according to the present invention further comprises a sub-process to emulate the process for scheduling tasks in the operating system with the at least one pre-defined scheduling method in the user space. In another preferred embodiment, the process for scheduling tasks in an operating system according to the present invention may further comprise a sub-process for dynamically switching the pre-defined scheduling methods at run time.

In most OS kernels, the two sets of components are combined and implemented as the “scheduler”. However, there are many benefits to separate the two sets inside the traditional kernel scheduler. First, it is much more difficult to write the second set of scheduler components 14 (also referred as the low level scheduler) than the first set of scheduler components 12 (also referred as the top level scheduler) since the low level scheduler is closely coupled with the exact structure and detailed functionality of the kernel. If we separate the two sets, it will be easier to design a new top level scheduler since the low level scheduler does not need to be changed. This makes the work of customizing scheduling algorithms much easier and/or foolproof Moreover, if the top level scheduler is separated from the low level scheduler, it is possible to let an application provide the mapping itself Applications can even implement schedulers using dynamic runtime conditions.

### Scheduling Attributes

This invention provides a flexible means so that real-time application developers may choose different scheduling policies tailored to specific application needs. A scheduler may switch between different scheduling algorithms at run time. In order for different scheduling algorithms to be supported in the scheduling process, it is important for all useful timing information about each task to be included in the system so that they can be used by the low level scheduler.

We define in this invention the following scheduling attributes for each task in a real-time system:

Priority: A task's priority defines the scheduling preference of the task relative to other tasks in the system.

Start time: The start time defines when a task may be executed. A task cannot be executed before its start time.

Finish time: The finish time of a task is its deadline. When a task reaches its finish time, it must be terminated even if the task has not finished its execution.

Budget: Budget is the allowed execution time of a task. A task will be terminated when its execution has used up its budget. It may include CPU budget and other resource budget.

The start time and finish time together define the eligible interval of a task execution. The priority specifies the relative order for sub-task execution; no sub-task can be executed if there is a higher priority sub-task eligible for execution. The budget specifies the total execution time assigned to a sub-task. These attributes thus are used as constraints. However, these timing attributes are also used as the selection function parameters when a low level scheduler needs to select a task or sub-task to be executed.

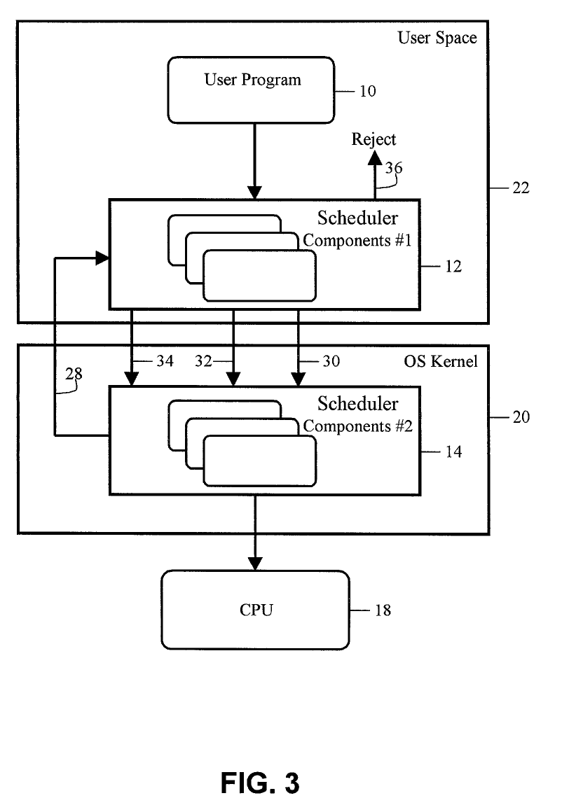

FIG. 3 shows two other functions of the first set of scheduler components. The first function is to divide a user program into multiple sub-tasks 30, 32, and 34. Given a user program, the top level scheduler 12 may transform the program into multiple sub-tasks, each with a different set of scheduling attribute values. This is necessary for translating the performance requirements between various scheduling algorithms. Another function is the capability to reject certain user tasks 36. In order to ensure that the low level scheduler 14 can guarantee that all sub-tasks on its waiting queue are executed, the top level scheduler may need to prevent some user tasks from entering the waiting queue of the low level scheduler. According to the present invention, the process for scheduling tasks in an operating system may comprise a sub-process of preventing a second user program from being processed by the second set of scheduler components if the first set of scheduler components determines that the operating system is not able to provide enough resources for the second user program.

### The Implementation of Dispatcher and Allocator

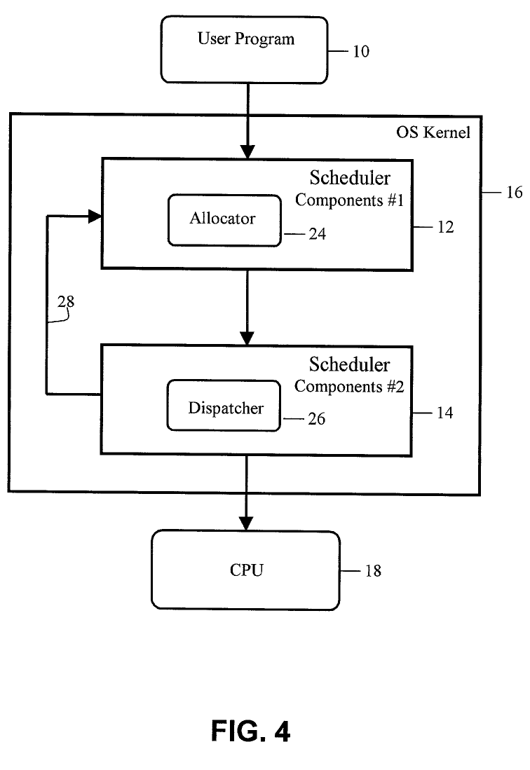

To show the feasibility and the flexibility of the present invention, we have implemented a two-component scheduler in a prototype system called RED-Linux. In FIG. 4, the two scheduler components are referred as Allocator 24 and Dispatcher 26, respectively.

### Dispatcher

Dispatcher is implemented as a kernel module in RED-Linux. Dispatcher is responsible for scheduling real-time tasks that have registered in Allocator. Dispatcher is used to determine the execution order as any traditional kernel scheduler. The basic unit of scheduling is sub-task instead of task. Dispatcher will move sub-tasks between several states. These states include ready, active, sleep, and end:

[Ready] This is the initial state of a sub-task. Sub-tasks in this state are kept in a priority queue sorted by their start time. A sub-task in the ready state will be moved into the active state at its start time.

[Active] Dispatcher will select one of the sub-tasks in the active state to execute next. A running sub-task will be moved into the sleep state if Dispatcher receives a sleep event (waiting for some resources). An active sub-task is moved to the end state at its finish time.

[Sleep] A sub-task in the sleep state is waiting for some system resources and cannot be selected for execution by Dispatcher. It waits for the wakeup event to return to the active state.

[End] Sub-tasks have reached its deadline or terminated.

Four queues are used in Dispatcher. They are:

1. Ready queue

2. Running queue

3. Sleep queue

4. Event queue

The first three queues are used to keep track of sub-tasks in each of the ready, active, and sleep states. The event queue is used to store events for Allocator. The events will not be generated by Dispatcher unless an event-mask of events is on. In addition, a wakeup-mask is used to control when Allocator should be waken up to handle these events.

For each sub-task, three timers are used to control its execution. A startup timer is used to move a sub-task into the active queue. A budget timer is used to move a sub-task to the end state when the sub-task's budget is used up. A finish timer is used to move a sub-task to the end state when a sub-task reaches its finish time. The expiration of start and finish timers is determined from the start time and the finish time of the sub-task directly. The budget timer is decided dynamically at run time. Whenever a sub-task as the next running sub-task is selected by Dispatcher, its budget timer is reset to the current time plus its remaining budget. Dispatcher is invoked whenever any timer expires. When Allocator creates a new sub-task, Dispatcher will be invoked to see if the new sub-task should be scheduled immediately. Finally, when a sub-task terminates Dispatcher will be invoked to select the next running sub-task.

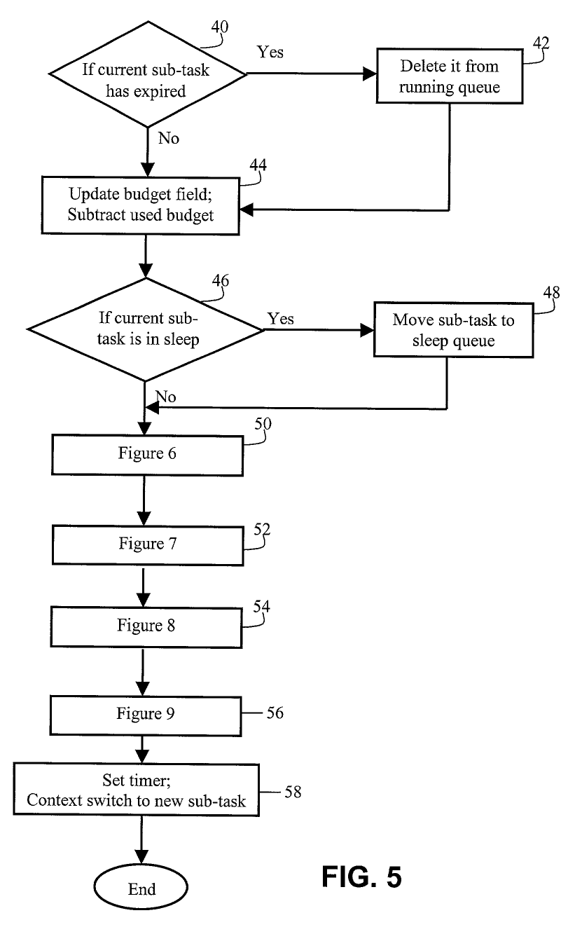

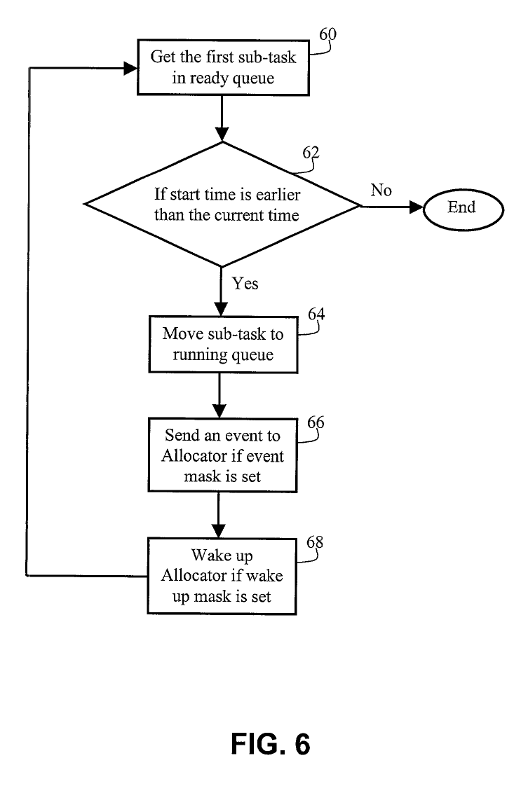

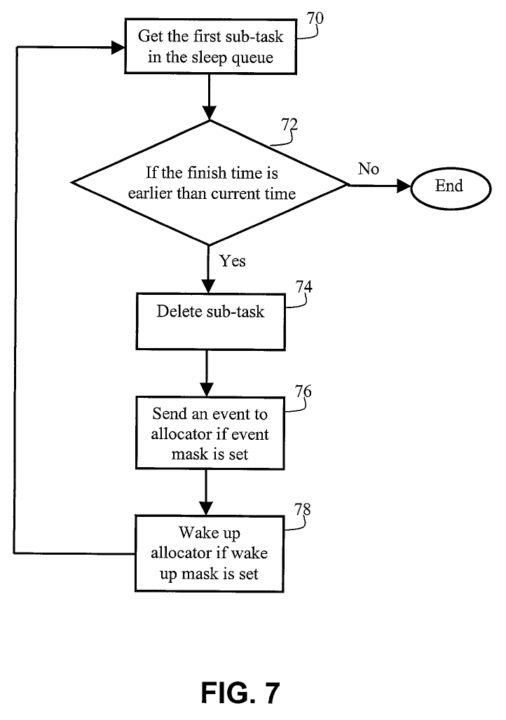

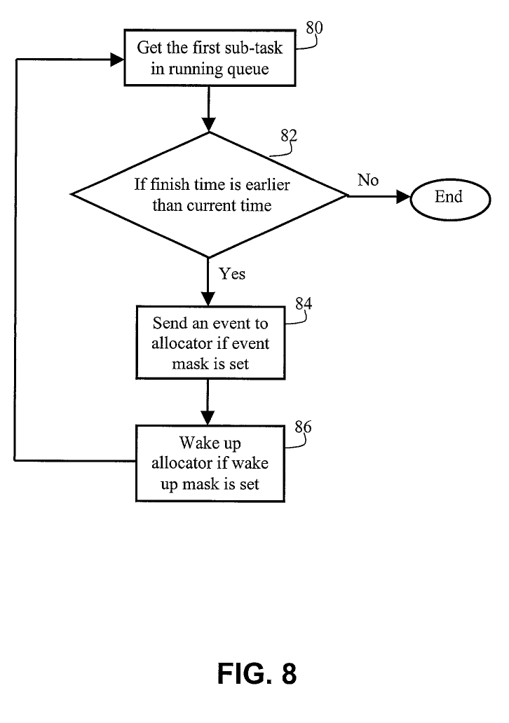

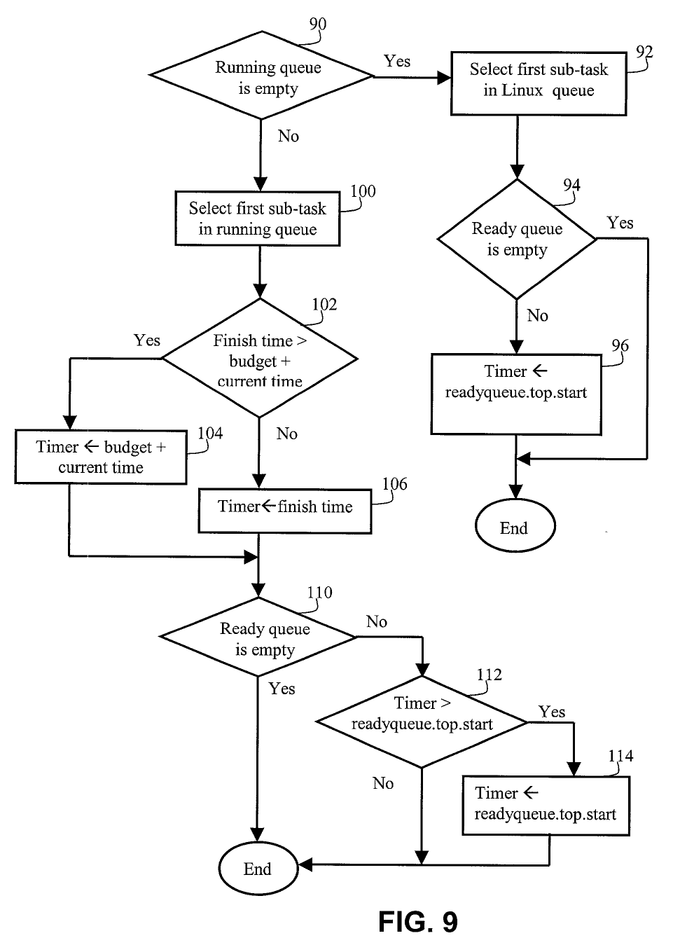

FIG. 5 shows the flowchart of the Dispatcher (that is, scheduler components #2 in FIG. 1) whenever it is executed. Dispatcher first decides if the current sub-task has used up its budget 40. If so, the sub-task is removed from running queue 42. The sub-task is updated to reflect the budget it has used 44. Dispatcher then checks if the current sub-task is in the sleep state waiting for some resources 46. If so, the sub-task is moved from the running queue to the sleep queue 48. After that, Dispatcher checks all three queues to update the status of all sub-tasks 50 (as shown in FIG. 6), 52 (as shown in FIG. 7), and 54 (as shown in FIG. 8), if necessary. Dispatcher then selects the sub-task to be executed next 56 (as illustrated in FIG. 9) and sets up a timer before starting the execution of the sub-task 58.

FIG. 6 shows the operation for updating the status of all sub-tasks in the ready queue. The sub-tasks are sorted by start time in the ready queue. Dispatcher checks the first sub-task in the ready queue 60. If its start time is later than the current time the checking is terminated. If the start time is earlier than the current time, the sub-task is moved to the running queue 64. The event is sent to Allocator 66 and Allocator is triggered if necessary 68.

FIG. 7 shows the operation for updating the status of all sub-tasks in the sleep queue. The first sub-task in the sleep queue is checked first 70. If its finish time is earlier than the current time 72, the sub-task is deleted from the sleep queue 74. Again the event is sent to Allocator if necessary 76 and Allocator is triggered 78.

FIG. 8 shows the operations for updating the running queue. The first sub-task in the running queue is checked first 80. If its finish time is earlier than the current time 82, the event is sent to Allocator if necessary 84 and Allocator is triggered 86.

FIG. 9 shows the Dispatcher operation for selecting the next sub-task to be executed by CPU. Dispatcher first checks if the running queue is empty 90. If so, Dispatcher selects a non-real-time task from the Linux scheduler queue 92. Dispatcher then checks if the ready queue is empty 94. If not, a timer is set to move the first sub-task in the ready queue to the running queue 96. If the running queue is not empty, Dispatcher selects the first sub-task from the running queue 100. It then prepares to set the next timer by checking the eligible execution interval for the sub-tasks 102, 104, and 106. After that, Dispatcher again checks if the time to move the first sub-task in the ready queue to the running queue is earlier 110, 112. If so, the timer is set to the move event time 114.

Dispatcher is designed to provide the scheduling mechanism for many different scheduling algorithms. It does not need to be modified even for different user applications.

### Allocator

The responsibility of Allocator is to assign the scheduling attributes of each sub-task according to the current state of the corresponding task. After a new sub-task is sent to Dispatcher, Dispatcher will schedule them according to their scheduling attributes.

Allocator is used to produce the sub-tasks stream according to the requirements of real-time tasks and the information inside the event queue. It will be called in two situations;

1. The running queue is empty; and

2. The wakeup-mask of specific events is on and there's at least one such event in the event queue.

Allocator is responsible for setting up the scheduling attributes. Dispatcher is to select a new sub-task to execute whenever a sub-task arrives, finishes or runs out of its budget. Since Dispatcher can schedule only in terms of sub-tasks, Allocator must divide tasks into individual sub-tasks. Each sub-task is assigned its own attributes based on the requirements of the application and the scheduling policy in effect. Allocator also determines the relative evaluation order of these parameters, and passes this information to Dispatcher.

In most implementations, Allocator will be running in the user space. It could be part of an application program or a server in the middleware, while Dispatcher is implemented in the kernel. The advantage of implementing Allocator in the user space is that system developers have more flexibility to modify the scheduling policy in order to meet the application's needs, without making any change to the kernel.

### Feedback From Dispatcher to Allocator

The execution status of applications, sub-task execution events, and the actual time already used by a sub-task can all be used to help run-time scheduling decision. For some scheduling policy, there is no need to monitor the actual execution status of tasks. But many algorithms need this information. For example, many tasks cannot pre-determine their execution time precisely. Another situation is that we may want to adjust the execution budget for a sub-task at runtime adaptively. If a sub-task always terminates before it uses up its budget, Allocator can reduce the reserved budget for next sub-task and give the extra time to other tasks. If a sub-task is always terminated before its completion, Allocator should give it more time so that it has a chance to complete. For implementing such schedulers, Allocator needs to know the exact execution behavior of sub-tasks.

Once Allocator passes a set of sub-tasks to Dispatcher, it will stand by and monitor an event queue. Dispatcher uses some pre-defined API to send sub-task events to Allocator. When Dispatcher makes any decision with regard to the sub-tasks in its queue, it adds an event to the event queue. Allocator can monitor this queue to see if it needs to make any further scheduling decision.

In addition to sub-task finish events, events including the exact time when a sub-task is executed, suspended, or terminated are sent to the event queue by Dispatcher. Allocator can request to be awakened when a particular type of event occurs in conjunction with any or all of the sub-tasks it has passed to Dispatcher. It can also be awakened when a new real-time task arrives. Once awakened, Allocator can make new scheduling decisions and pass on more sub-tasks to Dispatcher.

### Implementing Scheduling Algorithms using the Framework

Different scheduling algorithms require Allocator to update the scheduling attributes in a different way. On the other hand, when Dispatcher uses the attributes and makes scheduling decisions, it may use attributes in a different order. We now show how different scheduling algorithms can be implemented.

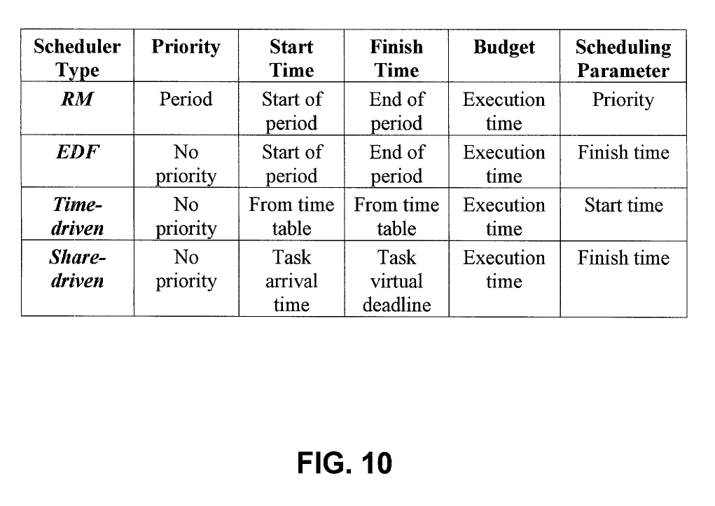

FIG. 10 shows how some simple scheduling algorithm may be implemented. For each scheduling algorithm, we show the actual value assigned to each sub-task attribute and also the scheduling parameter used by the Dispatcher. In the table, the smaller the priority value, the higher the priority. For example, in the well-known rate monotonic scheduling algorithm (RM), the smaller the period value, the higher the priority. No other algorithm in FIG. 10 except RM has a priority value. RM and Earliest Deadline First (EDF) are designed for periodic tasks. The period when a sub-task is created defines its eligible interval. The eligible interval for time-driven (TD) sub-tasks is defined by the TD scheduler used. For share-driven (SD) sub-tasks, their virtual deadline (computed by their shares and execution budget) defines the end of the eligible interval. In all schedulers, we assign the budget to be the pre-defined sub-task execution time.

In a generally preferred embodiment, an operating system using a plurality set of scheduler components and an operating system kernel comprises: (a) a first set of said plurality set of scheduler components having a plurality of sub-tasks, wherein said first set of scheduler components is a part of a user program for the operating system; and (b) a second set of said plurality set of scheduler components, wherein said second set of scheduler components is a part of the operating system kernel.

From the foregoing description, it should now be appreciated that an integrated multi-components scheduler for real-time operating systems has been disclosed. While the invention has been described with reference to a specific embodiment, the description is illustrative of the invention and is not to be construed as limiting the invention. Various modifications and applications may occur to those who are skilled in the art, without departing from the true spirit and scope of the invention, as described by the appended claims.

What is claimed is:

1. A process for scheduling tasks in an operating system using a plurality set of scheduler components comprising sub-processes of:
(a) given a user program, a first set of said plurality set of scheduler components dividing or transforming the user program into at least one sub-task;
(b) said at least one sub-task having a set of performance attributes, wherein values of said set of performance attributes are assigned by said first set of scheduler components;
(c) the first set of scheduler components placing the at least one sub-task on a waiting queue of a receiving scheduler component, wherein said receiving schedule component belongs to a second set of said plurality set of scheduler components; and
(d) said second set of scheduler components selecting a next sub-task to be executed by a CPU of the operating system from all sub-tasks on the waiting queue based on a selection function using the performance attributes of said all sub-tasks.

2. The process for scheduling tasks in an operating system according to claim 1, the process further comprising selecting the next sub-task having inputs from values of said set of performance attributes as in the sub-process (b).

3. The process for scheduling tasks in an operating system according to claim 1, wherein the plurality set of scheduler components comprises two scheduler components.

4. The process for scheduling tasks in an operating system according to claim 1, wherein the operating system further comprises an operating system kernel, the first and the second sets of scheduler components being part of said operating system kernel.

5. The process for scheduling tasks in an operating system according to claim 4, wherein the first set of scheduler components is a part of the user program and the second set of scheduler components is a part of the operating system kernel.

6. The process for scheduling tasks in an operating system according to claim 5, wherein the first set of scheduler components is selected from at least one pre-defined scheduling method in a user space.

7. The process for scheduling tasks in an operating system according to claim 1, 2, 3, 4, 5, or 6, the process further comprising a sub-process to emulate said process for scheduling tasks in said operating system with said at least one pre-defined scheduling method.

8. The process for scheduling tasks in an operating system according to claim 5, wherein the first set of scheduler components is selected from a plurality of pre-defined scheduling methods in a user space.

9. The process for scheduling tasks in an operating system according to claim 8, the process further comprising a sub-process for dynamically switching said pre-defined scheduling methods at run time.

10. The process for scheduling tasks in an operating system according to claim 9, wherein the first set of scheduler components defines scheduling policies and the second set of scheduler components implements scheduling mechanisms.

11. The process for scheduling tasks in an operating system according to claim 1, the process further comprising a sub-process of preventing a second user program from being processed by the second set of scheduler components if the first set of scheduler components determines that the operating system is not able to provide enough resources for said second user program.

12. An operating system scheduler using a plurality set of scheduler components comprising:
(a) a first set of said plurality set of scheduler components having a plurality of sub-tasks, wherein said first set of scheduler components is programmed to implement different scheduling policies and uses different algorithms for different user programs;
(b) a second set of said plurality set of scheduler components, wherein said second set of scheduler components uses a simple mechanism to select a next sub-task to be executed by a CPU;
(c) same set of scheduler components being used as the second set of scheduler components for different user programs; and
(d) the first set of scheduler components assigning different scheduling attributes to control the second set of scheduler components in selecting the next sub-task to be executed by said CPU.

13. The operating system scheduler using a plurality set of scheduler components according to claim 12, wherein said scheduling attributes are selected from the group consisting of start time of the sub-task, finish time of the sub-task, priority of the sub-task, total CPU budget of the sub-task, total system resource budget of the sub-task, real-time program parameters, and a combination thereof.

14. The operating system scheduler using a plurality set of scheduler components according to claim 13, further comprising at least a feedback generated from the second set of scheduler components, wherein the at least one feedback is forwarded to the first set of scheduler components, and wherein the at least one feedback comprises an execution status and an actual timing behavior of the sub-tasks.

15. The operating system scheduler using a plurality set of scheduler components according to claim 14, wherein the different algorithms used in the first set of scheduler components are dynamically switched after the first set of scheduler components receives the at least one feedback from the second set of scheduler components.

16. The operating system scheduler using a plurality set of scheduler components according to claim 12, wherein the plurality of sub-tasks is transformed from a single user program by the first set of scheduler components.

17. An operating system using a plurality set of scheduler components and an operating system kernel comprising:
(a) a first set of said plurality set of scheduler components having a plurality of sub-tasks, wherein said first set of scheduler components is a part of a user program for the operating system; and
(b) a second set of said plurality set of scheduler components, wherein said second set of scheduler components is a part of the operating system kernel.

18. The operating system using a plurality set of scheduler components and an operating system kernel according to claim 17, wherein the first set of scheduler components is selected from at least one pre-defined scheduling method in a user space.

19. The operating system using a plurality set of scheduler components and an operating system kernel according to claim 18, wherein the first set of scheduler components is selected from a plurality of pre-defined scheduling methods in a user space.

20. The operating system using a plurality set of scheduler components and an operating system kernel according to claim 19, wherein a first of the plurality of pre-defined scheduling methods in a user space of the first set of scheduler components is dynamically switched to a second of said plurality of pre-defined scheduling methods at run time.
